(19) United States
(12) Patent Application Publication
(10) Pub. No.: US 2008/0231857 A1
(43) Pub. Date: Sep. 25, 2008

(54) Sensor system and sampling cell assembly for use with sensor system

(75) Inventors: Christian Depeursinge, Preverenges (CH); Daniel Salzmann, Lussy-sur-Morges (CH)

Correspondence Address: MORGAN LEWIS & BOCKIUS LLP, 1111 PENNSYLVANIA AVENUE NW, WASHINGTON, DC, 20004, US

(73) Assignee: Radiometer Basel AG

(21) Appl. No.: 12/073,906

(22) Filed: Mar. 11, 2008

Related U.S. Application Data
(60) Provisional application No. 60/935,493, filed on Aug. 16, 2007.

(30) Foreign Application Priority Data
Mar. 12, 2007 (EP) 07388013.0

(51) Int. Cl. G01N 21/00; G01N 1/10

(52) U.S. Cl. 356/437; 356/246

(57) ABSTRACT

A sensor system for detection of a gaseous chemical substance is provided, which includes an optical sampling cell holding a sampling chamber of a volume of at most 20 mm³, a light emitter and a light receiver. The sampling cell is adapted for free-space, single monomodal propagation of the light beam. With the sensor system, high sensitivity is obtained by elimination of interferometric noise.

The present specification claims the benefit of priority and expressly incorporates by reference U.S. Provisional Application No. 60/935,493, filed on Aug. 16, 2007, and European Application No. 07388013.0, filed Mar. 12, 2007. The present invention relates to a sensor system and a sampling cell assembly for use with the sensor system.

Sensors for measuring parameters in a test fluid are widely used in various fields of chemistry, biology and physiology.

One such field is blood gas monitoring. The measurement of arterial blood gas parameters is an integral part of monitoring critical ill patients. Although analysis of arterial blood samples is considered to be the most accurate method for determining the blood gas status of a patient, the information provided by such punctual measurement reflects the situation only at the time a sample is taken. As blood gas values may change very rapidly in certain clinical conditions, in particular with patients having unstable respiratory or cardiopulmonary conditions, frequent or even continuous monitoring of blood gas parameters may be required to provide optimal care to the patient.

The need of such type of monitoring has led to the development of several invasive and non-invasive methods for the assessment of blood gas parameters. Among them, transcutaneous-monitoring of blood gases is the only non-invasive technique available today permitting the simultaneous measurement of both oxygen and carbon dioxide partial pressures. The method has the unique feature of providing instant knowledge of the body's ability to deliver oxygen to the tissue and to remove carbon dioxide via the cardio-pulmonary system.

Preferably, sensors should have a high sensitivity, i.e. the ability of the sensor to detect and distinguish the true parameter signal from false signals. Sensor sensitivity is related to sample volume requirements and to the response time. At high sample volumes, sensitivity is likely to be high, however, so is the response time. At lower sample volumes, response time may be reduced, however, so is the sensor sensitivity. On the other hand, in many cases large sample volume may not be available at all.

In terms of small sample volumes, reference may be made to Pandraud, G. et al. in “Sensors and actuators B”, Chemical 85 (2000) p. 158-162 where a sensor system for analysis of liquid samples is disclosed. The sensor system is based on evanescent wave sensing with an accent on optical absorption of the detected medium applying the Lambert-Beer law as read-out principle and micro-fluidic direct bonding for sampling cell construction and miniaturization. The resulting sample cell volume is about 0.8 mm³, well adapted for small volume analysis.

With many applications the analyte to be measured, however, may be in a gaseous phase, as is the case with blood gas monitoring. This, in turn, adds to the sensitivity requirements as the sample density for gaseous samples is low compared to liquid or solid samples.

In GB 2 219 656 a detection principle for analysis of gaseous samples is described which is a continuous signal (DC) detection using a collimated light beam and a retro-reflector. Before returning back through the incoming optical fiber, the light beam interacts within the gas over twice the cell length defined as the distance between the collimator and the reflector. However, as the light is returned into the incoming optical fiber, the forward propagating mode will interfere with the back propagating mode and generate a resonator signature (interferometric noise) which will lower the system performance.

The breath gas analyzer described in U.S. Pat. No. 6,599,253 is adapted for infrared spectroscopic monitoring the breath gas of a patient. The analyzer may detect gases in sample volumes in the order of 1000 mm³, corresponding to the requirements for human breath flow monitoring. For high frequent or continuous blood gas monitoring, however, the sampling volume is decades higher than the gas volume practically available, i.e. in the mm³-range.

In the particular field of transcutaneous blood gas sensing the requirements to the sensor system is to (1) access gas concentrations in the terms of gas permeation and diffusion within a short response time, (2) fulfil high sensitivity and high selectivity in a small volume, (3) access highly localized concentrations of blood gasses and (4) perform (1)-(3) in real-time monitoring.

With the introduction of the MicroGas 7650 in 1993, a new generation of transcutaneous monitors was introduced. This sensor comprises the basic elements of a Clark-type PO₂ sensor and a Severinghaus-type pCO₂ sensor. pCO₂ is measured potentiometrically by determining the pH of an electrolyte. A change of pH is proportional to the logarithm of a pCO₂ change. The pH is determined by measuring the potential between a miniaturized pH glass electrode and an Ag/AgCl reference electrode.

However, despite the hitherto proposed sensor systems for small volume gas detection, e.g. gas in permeation, there is still a need for a sensor system which may combine high sensitivity, low sample volume and short response time. Accordingly, it is an object of the present invention to provide such a sensor system. Calibration-free operation, i.e. calibration during manufacture only, is preferred as well.

Thus, in one aspect of the invention, a sensor system for detection of a gaseous chemical substance in a medium is provided, which comprises an optical sampling cell holding a sampling chamber of a volume of at most 20 mm³ for receiving a sample including the chemical substance, a light emitter for generating and coupling a light beam into the sampling cell for free-space propagation along a light beam optical path within the sampling cell for interaction with the sample held in the sampling chamber, and a light receiver to detect the light beam from the sampling cell and to produce an output signal indicative of the chemical substance of the sample.

Compared to prior art sensor systems, the light beam propagates by single monomodal propagation.

The present sensor system requires only a very small sample volume of gas. Further, it provides simple operation and has a higher sensitivity compared to the sensor technology described in e.g. WO03/023374 which is based on evanescent wave sensing.

The sensor system of the present invention provides precise operation as the optical measurement principle is based on the physical properties of the chemical substance detected. No chemical reactions are necessary, and it is possible for no chemical reactions to be involved.

In the field of transcutaneous blood gas monitoring the sensor system allows frequent or even continuous monitoring of the ventilation of a patient by measuring non-invasively the arterial pCO₂ with a precalibrated and easy to use monitoring system.

Thus, whereas the previously available systems are based on electrochemical principles and need to be frequently recalibrated and thus must include a calibration unit, the new system detects the chemical substances by optical means in a small optical sampling cell at the surface of a transcutaneous sensor by using an optical technique, preferably a modulation spectroscopy technique. The sensor is preferably precalibrated at the factory and is free of any drift.

It should be understood, however, that the sensor system, beyond the transcutaneous application, may be used for monitoring chemical substances within a large number of technical fields, including other clinical fields, chemical and food industry, bio-degradation, and for the monitoring of environmental parameters. Thus it may used in various fields of chemistry, biology, physiology, gas analysis, gas safety, monitoring of gas production and in microstructure processing, automotive, environmental, biological and food industries as well as within gas and liquid chromatography.

The sensor system of the present invention allows the operator to measure permeating gases and very small gas flows. For example, a few micro-liters per minute of gas can be measured in the minute range response time, which is the case in transcutaneous blood gas monitoring where a very small gas flow is permeating out of the patient skin. The system may determine gas concentrations either applied on the medium, meaning at the interface, (e.g. on human skin with a surrounding adhesive, built-in on a bioreactor wall, on a foil to characterize its gas diffusion properties) or directly within the medium, meaning as a probe (e.g. inside the human stomach for gastric gases analysis, for biodegradation monitoring at different depth in the bio-reactor).

Out of the all the chemicals and isotopes potentially measurable by the present system, a non-exhaustive list of the most common targeted chemicals includes CO₂, O₂, H₂O, NO₂, C₂H₄, NH₃, CO, HBr, HF, C₂H₂, H₂S, HI, CH₄, HCN, NO, SO₂, HCHO, N₂O, HCl, NO₃, and CH₃COCH₃ (acetone). In the field of medical applications CO₂, O₂, H₂O, CO, anaesthetic gases, N₂O and acetone are of particular interest.

As used herein, the term “optical sampling cell” means a body for holding a sample for analysis by optical means. It should be understood that the term “cell” relates to the any sampling chamber within the cell as well as to the body of the sampling cell.

As further used herein, the term “sampling chamber” means a chamber within the sampling cell for receiving a sample comprising the chemical substance. The sampling chamber has a certain volume and may be void, or it may be filled with a porous material which allows relatively unhindered diffusion of the sample of gas, however, which in turn reduces the volume of the sampling chamber available for the gas.

The volume of the sampling chamber may be at most 20 mm³.

It should be understood that the propagation of the optical beam may take place within the sampling chamber as well as within the body of the optical sampling cell. It should be further understood, that such propagation is considered as free-space propagation as opposed to any waveguide propagation where the waveguide core or cladding is based on a bulk solid phase material of higher refractive index than free air or gas. Thus, whereas with the waveguide propagation the sensing is obtained through its evanescent wave, which is a non propagating wave mostly defined with an exponential decay perpendicular to the direction of propagation, the beam propagation of the present invention is meant to perform the sensing through its propagating wave within the direction of propagation.

Thus, as used herein, the term “free-space propagation” means that the light propagates within the gaseous phase of the sampling chamber, within any porous material of the sampling chamber or within the body of sampling cell, however not within any kind of solid state waveguide as otherwise described in the prior art, e.g. in WO03/023374.

The term “light emitter” shall mean any structure which provides, generates, shapes and transmits the light beam into the sampling cell. Thus, light emitter shall comprise a light source, light source controller, light transmitter, e.g. a fiber, lenses, collimators and beam splitters.

The term “light beam optical path” should be understood as the propagation path of the light beam within the optical sampling cell. The propagation may take place within the gaseous phase of the sampling chamber, within any porous material thereof as well as within the body of the optical sampling cell. It should, however, be understood that interaction with the gaseous sample takes place only within the gaseous phase of the sampling chamber and not within the body of the sampling cell, so that interaction between the light beam and the chemical substance may appear only along part of the light beam path.

The term “light receiver” means any structure which receives, transmits and transforms the light beam from the sampling cell. Thus, light receiver shall comprise a light detector, light transmitter (e.g. a fiber), transformer, (e.g. filter, analogue and/or digital electronics, microcontroller, signal analysis/fitting, normalization process, calibration algorithm, security controller, communication controller) and amplifier.

The light beam may propagate by single monomodal propagation, which means light beam propagation with no interaction or interference between individual optical modes. Thus “monomodal propagation” means that only one optical mode propagates along the system, or, in case a plurality optical modes propagates, each mode propagates without interfering with itself or any other propagating mode. For example, the sampling chamber surrounding the light beam should keep the propagation monomodal and not perturb the light beam at points where the free-space propagating mode is converted in several modes as otherwise interference and parasitic noise occur.

It should be emphasized that polarization modes of orthogonal orientations do not interfere with each other and might propagate throughout the system without generating parasitic noise or interferometric noise.

It also should be noted that the monomodal propagation of the light beam occurs along the full light beam optical path, i.e. within the sampling cell. Preferably, however, the light beam propagation is monomodal within the light emitter and the light receiver as well, and thus through any light transmitter, e.g. waveguides, from the light source to the light detector.

The term “single propagation” is used to mean a uniquely forward propagation of the light beam where reflection, refraction, diffraction or scattering of the light beam do not occur or do not interfere with the light beam itself.

Typically, etalon fringes, which are considered as the main contributor to parasitic noise, originate from a partial back reflection folding the beam on itself and interfering with it. With the present invention, the entire system and in particularly the sampling cell are adapted to the beam shape, its cross-section and its optical path in order to fulfil the single monomodal propagation for the high performance sensor system. For example, the shape of the sampling chamber can be fabricated according to the Gaussian beam shaped by light emitter, so that negligible perturbation occurs.

Practically, monomodal propagation is preferably provided by choosing a narrow band light emitter, such as distributed feedback (DFB) laser diodes, vertical-cavity surface-emitting lasers (VCSEL) and quantum cascade lasers, providing a single longitudinal mode.

The single monomodal propagation of the invention ensures the desired reduction in parasitic noise, originating from refractive index discontinuities, intermodal interferences, beam propagation perturbation, beam partial scattering, etc. Such noise reduction may be achieved if the beam stays monomodal and propagates once from, and along, the light emitter to, and along, the light receiver.

It should be understood that in particular with the small sampling volume of the present invention, the single monomodal propagation is essential in order to reduce any kind of parasitic noise and thus provide a high sensitivity of the sensor system.

In case of free-space propagation, monomodal propagation is preferably provided by selecting the zero order mode of the Helmoltz equation, which general solutions are described in Saleh et Teich (1991, ISBN 0-471-83965-5, p 81, 100, and 104) with Hermite-Gauss, Laguerre-Gauss and Bessel intensity distributions approximated by a Gaussian beam. Practically, in order to obtain monomodal propagation, a light source of a narrow band width is preferably selected, i.e. the band width should be narrow compared to the gas absorption lines and preferably of single longitudinal mode.

As to the sampling volume, Fetzer, in “Tunable diode laser absorption spectroscopy in coiled hollow optical waveguides”, Applied Optics, June 2002, vol. 41, no. 18, discloses a sensing system have a flow rate of 60 cm³ per minute. Such system has a short response time. The system is based on a hollow optical fiber of Ø=1 mm and a length of approx. 4 m corresponding to a sampling chamber volume of approx. 4 cm³. According to the disclosure of Fetzer, the sampling volume of such system may be reduced to 50 mm³ (Ø=0.25 mm and length 1 m), however, not beyond that figure. In this way the system may be adapted for exhaled breath analysis, but not for transcutaneous blood gas monitoring, which require volumes in the mm³-range and transport related to gas diffusion only. The present invention solves this problem by reducing the sampling volume below 20 mm³, allowing gas concentration equilibrium to be reached in a short response time. For example, with the application of oxygenation monitoring of transplanted skin, local sensing of blood gases permeating through the skin and indicating the success of the transplantation is required. In this case, the blood gases flow through the skin is limited by skin diffusion and any sampling volume larger than 20 mm³ would increase the response time to an unacceptable level for this application.

According to a preferred embodiment of the invention the volume of the sampling chamber is at most 5 mm³.

One application of the sensor system of the present invention is the continuous blood gas monitoring for neonates or adults. Such ventilation determination requires a short response time of less than 1 minute to avoid any cerebral damage (hypoxeamia or hyperoxeamia), e.g. in case of cardio-pulmonary disorder. In a preferred embodiment of the present invention this problem is solved by the definition of a sampling volume smaller than 5 mm³ allowing the gas concentration equilibrium to be reached in the required short response time. Such smaller sampling volume may be obtained in at least two ways, either by adapting the sampling chamber to the shape of the light beam emitted so that the sampling cell does not perturb the light beam or by adapting the sampling cell so that the light beam is guided but still propagating in free-space.

According to a further preferred embodiment of the invention the volume of the sampling chamber is at most 0.5 mm³.

Among the applications of the sensor system of the present invention, biodegradation monitoring and control requires an ultra-small sampling volume, below or in the order of 0.5 mm³. Such low sampling volume allows real-time resolution and in turn continuous control of the bioreactor substrate and oxygen supply for optimal degradation speed.

For example, Grima, in “A New Test Method for Determining Biodegradation of Plastic Material Under Controlled Aerobic Conditions in a Soil-Simulation Solid Environment”, Journal of Polymers and the Environment, vol. 9, no. 1, January 2002, discloses the degradation of cellulose in soil providing 10 mm³/min (20 μg/min) of CO₂ from a 400 cm³ substrate volume. Assuming a cubic substrate of a total surface of 326 cm², the resulting gas permeation rate is 0.03 mm³/(min cm²). Thus, attaching the sensor of this embodiment of the invention and having a sensing area of 15 cm² to such cellulose bioreactor, the sampling volume of 0.5 mm³ corresponds to a response time of the present sensor system of less than 60 sec, which is acceptable for biodegradation monitoring and control. The expensive mass spectrometer or liquid chromatography usually applied for degradation monitoring does not resolve such short response time.

With the present invention the design of the sampling chamber (or part of it) is preferably adapted to the light beam path and the light beam cross-section along the path, in order to optimize the sampling chamber volume (and consequently the system response-time) without perturbing the light beam. By “without perturbing the light beam” it is meant that the light beam perturbation generating parasitic noise (interferometric noise) stays negligible compared to the required sensor system performance, e.g. resolution, stability, and accuracy. For example, Gaussian beam equations can be used for such adaptation.

In a preferred embodiment of the invention, the internal surface of the sampling chamber is coated, preferably with a chemically and/or optically active coating. Chemical coatings may catalyse certain chemical reactions which may convert the chemical substance into another chemical substance, which may be more easily detectable than the first chemical substance. Optical coatings may help for either guiding or shaping the light beam, or for reducing interferometric/parasitic noise.

In a preferred embodiment of the invention the sensor system includes a guiding structure in which the light beam propagates.

As used herein, the term “guiding structure” means a hollow cavity acting to guide the free-space propagation of the light beam within and optionally beyond the sampling cell in order to limit the extension of the light beam and potentially to extend the interaction length between the light beam and the chemical substance. In contrast the waveguide disclosed in WO03/023374 is based on a core or cladding of bulk solid phase material where most of the guided light propagates within the solid material and not in gaseous phase, i.e. free-space, as meant in the guiding structure.

With the guiding structure, monomodal propagation of the light beam may be provided in an alternative way to the narrow band width light source. Accordingly, the guiding structure dimensions may be selected to promote the monomodal propagation of the light beam.

Thus, for particular geometries of the guiding structures the monomodal propagation depends on the numerical value of the ratio D/λ, where D is a characteristic dimension of the guiding structure and λ is the wavelength of the light beam applied.

Thus, for a rectangular mirror guiding structure which has a characteristic dimension Dₘᵢᵣᵣₒᵣ, Dₘᵢᵣᵣₒᵣ/λ<(π)^{-0.5} should be fulfilled in order to have monomodal propagation. In this context it should be understood that a “mirror guiding structure” is a structure with a reflecting inner surface, such as a gold coating.

Likewise, for a rectangular dielectric guiding structure which has a core and a dielectric cladding, a characteristic dimension D_{dielectric} and a numerical aperture NA defined as (n₁²-n₂²)^{0.5}, where n₁ and n₂ represent the dielectric core and the dielectric cladding refractive indices, respectively, D_{dielectric}/λ<1/(π^{0.5}*NA) should be fulfilled in order to have monomodal propagation. In this context it should be understood that a “dielectric guiding structure” is a structure made of dielectrics with a dielectric core and dielectric cladding displaying different refractive indices.

Further, for a circular dielectric guiding structure of a diameter D_{circular} and a numerical aperture NA_{circular}, D_{circular}/λ<2.405/(π*NA_{circular}) should be fulfilled in order to have monomodal propagation.

Generally, the characteristic dimension D may be taken as the longer dimension of the guiding structure cross-section, e.g. the longer side of a rectangle. Thus, if monomodal propagation occurs with respect to the longer dimension, it also occurs with respect to the shorter. On the other hand, if it does not occur with respect to the shorter dimension, it does not occur at all.

The characteristic dimension D may be evaluated for a number of prior art set-ups. With such evaluation the shorter dimension of any cross-section is evaluated.

Thus, Lambrecht (Lambrecht, A. et al, “Miniature infrared gas sensors using photonic crystals”, Proc. of SPIE, vol. 6480, p. 68400D-1-68400D10, February 2007) discloses an infrared gas sensor based on photonic crystals which displays a sampling volume of a characteristic dimension (section) of 400 μm. Using a 4.24 μm wavelength thermal source, the D/λ-value is in the range of 100 (400 μm/4.24 μm) which reflects a highly multimodal, and thus not monomodal propagation.

Likewise, the thermal source used by Lambrecht provides a broad band width compared to the gas absorption lines. This also reflects the resulting multimodal propagation.

Ritari (Ritari, T. et al, “Gas sensing using air-guiding photonic bandgap fibers”, OPTICS EXPRESS, vol. 12 (17), p. 4080-4087, August 2004) discloses a gas sensor of a sampling volume (vacuum chamber) of a characteristic dimension D of 10 μm. With a 1.5 μm wavelength, the D/λ-value is in the range of 7 (10 μm/1.5 μm). The D/λ-value indicates multimodal propagation within the vacuum chamber. Further, it should be noted that Ritari uses a multi-mode fiber between the vacuum chamber and the detector. Accordingly, with his set-up, Ritari does not provide monomodal propagation over the entire optical path from light source to detector.

Kozodoy (Kozodoy, R. et al, “Small-Bore Hollow Waveguide Infrared Absorption Cells for Gas Sensing”, Applied Spectroscopy, vol. 50 (3), p. 415-7, March 1996) discloses a gas sensor with a sampling volume of a characteristic dimension D of 250 μm. With a 4.26 μm wavelength from a thermal source, the D/λ-value is in the range of 60 (250 μm 14.26 μm). The D/λ-value along with the broad band width thermal source reflect the resulting multimodal propagation.

With Kong (Kong Fanliang and Depeursinge, C., “Optical sensor for transcutaneous CO₂ measurement: Design principle and feasibility study”, Chinese Journal of Biomedical Engineering, vol. 11 (3), p. 186-198, September 1992) similar considerations apply with the D/λ-value being in the range of 50 (200 μm/4.2 μm). Thus, in turn, the D/λ-value along with the broad band width thermal source reflect the resulting multimodal propagation.

Fetzer, who was referred to above, discloses a sampling volume of which the characteristic dimension D is Ø=0.25 mm and as a light source a distributed feedback laser with a wavelength of 1.5 μm. Accordingly, the D/λ-value of the system of Fetzer is in the range of 150 (250 μm/1.5 μm). Thus, even though the laser of Fetzer is of the narrow band width type and may have been applicable for proper monomodal propagation, the D/λ-value reflects the multimodal propagation operation.

Thus, none of these references disclose the monomodal propagation of the present invention.

Preferably the sampling cell comprises the guiding structure, i.e. fully or at least partly arranged within the sampling cell.

It should be understood that according to the invention the guiding structure may extend as well beyond the sampling cell. Thus the guiding structure may be extended in the direction of the light emitter, i.e. that the guiding structure may guide the light beam before or at the entrance of the sampling cell. Likewise the guiding structure may be extended in the direction of the light receiver, i.e. that the guiding structure may guide the light beam at or beyond the exit of the sampling cell. Thus the guiding structure may be connected, e.g. by gluing or splicing, to the light emitter and/or the light receiver.

The guiding structure may be any tubular device of any cross-section, whether circular, rectangular or elliptical which shows at least partially reflecting internal surface. The term “partially reflecting” means that the guiding structure is so adapted as to allow the light beam to propagate in such a way, that less than 100% of the light intensity is lost during the propagation along the guiding structure. The partial reflectivity of the guiding structure is typically provided by having a smooth surface. By “smooth surface” is to be understood that any surface structure, including any surface porosity, is significantly smaller than the wavelength of light, so that little or no scattering of the light beam occurs relating to such surface structure or porosity.

On the other hand it should be understood that the guiding structure may in fact be porous in order to allow the chemical substance to diffuse across the surface of the guiding structure. Thus, a typical implementation uses a miniature gold tube with polished internal surface achieving long interaction length, which improves the system sensitivity as well as reducing the sampling volume to provide a short response time. Preferably, the guiding structure is selected from the group of tubes (capillaries), hollow fibers, multi-hole fibers and photonic band gap devices. It should be understood, however, that any porosity of the guiding structure is on the molecular level, i.e. several orders of magnitude smaller than the wavelength of the light used in the sensor system.

In a particular embodiment, hollow core optical fibers and hollow core photonic crystal fibers (hollow core PCF) wherein up to or even more than 95% of the light is travelling in the hollow core, are used for free-space propagation along the guiding structure. The sensing performed by such fiber is obtained by propagating waves.

Alternatively, the guiding structure is non-porous to the gaseous chemical substance.

In some cases the guiding structure is chemically inert, e.g. as the above gold tube. In a preferred embodiment of the invention, however, it may be coated with a chemically and/or optically active coating. Chemical coatings may catalyse certain chemical reactions which may convert the chemical substance into another chemical substance, which may be more easily detectable than the first chemical substance. Optical coatings may interact with the chemical substance to create a detectable output signal.

In a preferred embodiment of the invention the guiding structure receives the gaseous sample. Thus, as the guiding structure is at least partly arranged within the sampling cell and extends across the sampling chamber thereof, the guiding structure may be the part of the sample cell which receives the gaseous sample. Such arrangement of the guiding structure further reduces the volume of the sample chamber and the response time required for a proper detection of the chemical substance.

In one embodiment of the invention the guiding structure is straight. Such straight guiding structure provides the smallest sampling chamber volume and may be applicable with sensor systems of high sensitivity and easily detectable chemical substances.

In another embodiment of the invention the guiding structure is bent, coiled, folded, U-shaped or spiral-shaped. With such guiding structures the light beam optical path is extended, while still keeping the volume of the sampling chamber and the overall sample cell volume at a low level. The extended light beam optical path improves the system sensitivity, and may as such be applied with less detectable chemical substances.

In order to obtain monomodal propagation, and in turn optimal reduction of the interferometric noise, the light source is preferably selected from sources which have a narrow band width, i.e. the band width should be narrow compared to the gas absorption lines.

Thus, in a preferred embodiment of the invention the light emitter is a narrow band light emitter, preferably selected from the group of distributed feedback laser diodes, vertical-cavity surface-emitting lasers and quantum cascade lasers.

The band width may be related to the relevant absorption line of the gaseous chemical substance. Thus the light emitter has preferably a band width at −3 dB of at most the FWHM (full width at half maximum) of the gaseous chemical substance absorption line.

In a preferred embodiment of the invention the light emitter comprises a collimator. By means of the collimator, the light beam may be limited and defined in terms of direction and angular divergence. In this way parasitic noise may be reduced.

For the best possible light beam propagation, and in order to further reduce interferometric noise, at least one of the light emitter and the light receiver preferably comprises a beam shaper. By “beam shaper” it is meant any device to modify the light beam wavefront, preferably a collimator, a lens, a graded index lens (GRIN, Selfoc) or diffractive grating. Preferably the light emitter comprises a beam shaper.

One embodiment of the present invention uses an optical waveguide on at least one of the light emitter and/or the light receiver. In a preferred embodiment an optical waveguide is used on the light emitter. In another preferred embodiment of the invention an optical waveguide is used on both of the light emitter and the light receiver. Preferably the optical waveguide is a fiber or a lensed-fiber, which latter also fulfils the collimator or beam shaper function. Fibers and lensed-fibers ensure a proper transmission with a minimum of loss and noise from the emitter to the sampling cell and from the sampling cell to the receiver.

One embodiment of the present invention uses a lensed-fiber encompassing the collimator (lens) within the fiber tip (the lensed-fiber may be considered as a drop-like ball (or particular shape) of glass formed, glued or soldered at the fiber tip). The lensed-fiber output wavefront may be customized from strongly focusing (typically in the range of a few microns for beam-waist-diameter and a few microns for distance-to-beam-waist) to almost collimating (typically less than one hundred microns for beam-waist-diameter and several millimeters for distance-to-beam-waist). Diverging beam is also possible. In combination with a sampling cell closely surrounding the light beam the resulting sensor system achieves the short response time required in many critical application fields.

In a preferred embodiment of the invention the light emitter includes a beam splitter. By means of the beam splitter the light beam is split into a sampling cell light beam and a reference light beam. It should be understood that the sampling cell light beam is passed across the sampling chamber, whereas the reference light beam is not to be passed across the sampling chamber. Instead, the reference light beam propagates to the light receiver, e.g. in a separate waveguide, or across the sampling cell, however, without interacting with the chemical substance. It is preferred to use the reference light beam for comparison to the sampling cell beam for better system performance, e.g. common-mode rejection.

In a preferred embodiment of the invention the light emitter is wavelength-modulated or frequency-modulated. Further, the light receiver may be adapted for fundamental and/or harmonic detection.

In a preferred embodiment of the invention, and combined or not with the above wavelength- or frequency-modulated light, the wavelength (or frequency) may be swept over the wavelengths (or frequencies) of an appropriate absorption peak of the chemical substance. The resulting signal, corresponding to the signature of the absorption peak, may be compared to a 100% transmission and/or a reference signal to produce the chemical substance signal. Without wavelength-modulation (or frequency-modulation) the direct absorption gas signal is generated, whereas combined with wavelength-modulation (or frequency-modulation) the harmonic (also called derivative) signature of the absorption peak is generated.

With alternative embodiments of the invention, the light receiver may be adapted for fundamental and/or harmonic detection. With fundamental and harmonic detection by the light receiver, the first, second or higher order derivative of the absorbance spectrum may be detected. In case the demodulation is performed at a frequency equal to the wavelength modulation frequency, the first derivative of the absorption spectrum may be observed, referred to as fundamental detection (or first harmonic detection). In case the demodulation is performed at a frequency twice the wavelength modulation frequency, the second derivative of the absorption spectrum may be observed, referred to as the second harmonic detection. Using a similar technique, higher harmonics may be detected as well. A combination of different harmonics detection may also be applied for better system performance.

Wavelength- or frequency modulated spectroscopy and fundamental and harmonic detection allow for a highly efficient noise reduction and a high sensitivity of the sensor system.

In a preferred embodiment the sensor system applies wavelength modulation of a laser diode by modulating its current or temperature and performs narrow bandwidth detection at the fundamental or/and harmonic(s) of the modulation frequency.

Thus, in a preferred embodiment of the present invention wavelength modulation is used to minimize noise contamination of the signal delivered by modulation techniques. From the state of the art it is known that signal-to-noise ratio in high sensitivity wavelength modulation spectroscopy is limited by the so-called “interferometric noise” originating from light interference between two or a plurality of partially reflecting interfaces or intermodal interference. For instance, non-adiabatic transitions of the refractive index along the light propagation, provides partially reflecting interfaces. Discrete elements based sensor systems suffer from multiple air-glass interfaces (fiber-air, air-collimator lens, etc) generating interferometric noise.

In order to reach the high sensitivity with modulated spectroscopy, interferometric noise should be reduced. In a preferred embodiment this may be done by the use of a single mode light emitter such as a distributed feedback (DFB) laser diode or a vertical cavity surface emitting laser (VCSEL) or any kind of suitable laser providing a narrow spectral emission (related to the gas absorption peak width), coupled to a single-mode fiber, itself coupled as a single mode in free-space and propagating in the sampling cell. The light beam, in turn, may be described by a Gaussian beam (Hermite-Gaussian, Laguerre-Gaussian or Bessel beams) which can be easily generated and further collected by a lensed fiber.

Further, statistical treatment is used to eliminate the residual interferometric noise. Statistical treatment may be applied to the signal after intentionally perturbing or scrambling some parameter affecting residual interference, e.g. by means of a thermo-mechanical actuator. Spectral averaging contributes to interference noise rejection.

In a preferred embodiment of the invention a calibration-free operation of the sensor system may be obtained by comparing, in the light receiver, the chemical substance signal to the direct transmission of the reference signal or to the sampling cell signal acquired outside the sensed chemical substance absorption spectra. In the case of wavelength-modulation or frequency-modulation, calibration-free operation may also be obtained by comparing the harmonic signal to the sampling cell direct transmission, to the direct transmission of the reference signal, or to the harmonic signal of the reference signal. Any combination of the above comparisons may also be applied and is hereby referred as “normalization process”.

With calibration-free operation of the sensor system, the signal reflecting the chemical substance may be determined by an in-situ calibrated process which is completely free of any other calibration processes. In particular, the determination is free of any calibration process step which should otherwise be performed as separate steps before or after the sample determination.

In a preferred embodiment of the invention the shape of the light beam optical path is modified by refraction, reflection, diffraction or scattering within the sampling cell, within the sampling chamber or within the guiding structure.

By such modification of the light beam optical path, the path length is extended in order for the light beam-chemical substance interaction to be increased. With each of the phenomena of refraction, reflection, diffraction and scattering the light beam optical path deviates from straight propagation and the path length is consequently extended.

It should be understood that according to the invention the above light beam path modification in terms of refraction, reflection, diffraction or scattering is performed in such a way that it does not introduce any significant interferometric noise. Thus the modification is done in such a way that the refracted, reflected, diffracted or scattered light beam does not interfere with itself, and that no additional interfering light beam modes are introduced with the refraction, reflection, diffraction or scattering.

For example, the light beam from the light emitter, propagating in the sampling cell, may be split by the use of a beam-splitter cube generating a reference signal and a sampling cell signal through refraction and partial reflection. Then the optical path in the sampling cell can be folded by the use of a mirror (flat or concave with total reflection) so that the gas-light beam interaction is doubled while the sampling cell is kept compact. The folded light beam must be tilted to avoid back-reflection interference. The light receiver may be placed next to the light emitter.

The sampling cell of the sensor system according to the invention preferably comprises a membrane. The membrane may be arranged with the sampling cell adjacent to the sample chamber.

With the membrane any unwanted interaction between the medium and the light beam may be reduced. Indeed, many applications require separating the sensed chemical substance from the rest of the medium. Thus, for sensing of a gaseous chemical substance, the membrane prevents liquids or solids from the medium from interacting with the light beam, while allowing the gaseous chemical substance to diffuse across the membrane into the sampling chamber.

It should be understood that the membrane may have varying properties relating to the diffusion of the chemical substance or the propagation of the light beam. Thus, the membrane may be coated and/or may have bulk properties, i.e. the membrane material itself, with a chemical or optical activity. A chemical activity may allow the conversion of the chemical substance into another substance, which may be easier to detect. In a preferred embodiment of the invention the membrane comprises enzymes which may convert the chemical substance into another substance which may be easier to detect. Thus, the membrane may comprise glucose oxidase, which converts glucose into hydrogen peroxide. An optical coating of the membrane may interact with the light beam for supporting the sampling cell functionalities.

The membrane may be chemically inert or it may be reactive as described above. Preferably it should be selective. For this purpose, it has a selected porosity and/or chemical structure.

The membrane may further be based on a sandwich structure to fulfil several requirements such as separation, prevention of fouling, mechanical rigidity and ease of assembly.

The membrane may further have a controlled surface roughness or a controlled surface structure. Thus, the membrane may be adapted to shape the part of the sampling cell receiving the gas sample in such a way that a maximum amount of sample may be received while keeping the volume of this part as small as possible. It should be understood that the sampling cell should still allow a proper diffusion of the chemical substance within the sampling cell. This may be achieved by a sampling cell construction according to which the part of the sampling cell receiving the sample is defined by the membrane surface roughness or the membrane surface structure. Thus the membrane may be arranged adjacent to the sampling cell wall so that the only space for diffusion of the chemical substance between the membrane and the sampling cell wall is the space left by the membrane surface roughness or structure. The combination of the membrane roughness/structure with the sampling cell wall roughness/structure also applies to allow proper gas diffusion while keeping the volume of the sampling cell small.

The membrane may be fixed with or removable from the sampling cell, or the membrane may be integrated within part of the sampling cell to form an exchangeable/disposable part of the system.

In a preferred embodiment of the invention the membrane and at least part of the sampling cell are integrated into a sampling cell assembly. According to this embodiment the sampling cell assembly may be exchangeable or disposable.

With an exchangeable sampling cell assembly the assembly may be adapted for various measurement conditions like sampling volume (e.g. for adapted measurements on adults and infants), temperature and humidity.

With a disposable sampling cell assembly, the assembly may be changed with every single measurement, in order to minimize inter-sample contamination.

With another preferred embodiment of the sensor system according to invention the system comprises a medium pipe crossing the light beam.

The term “medium pipe” means a flow structure for continuously transporting the medium across the light beam for interaction therewith. Such medium pipe is especially applicable for the continuous monitoring of chemical substances, e.g. in gas production environments.

It should be understood that the medium pipe may be an integrated part of the sampling cell or it may be arranged adjacent to the sampling cell in such a way that the chemical substance may continuously be monitored by the sensor system when flowing in the medium pipe.

In a preferred embodiment the sampling cell has a sampling area for sampling the chemical substance.

The term “sampling area” means an area of the sampling cell devoted to sample collection. Preferably the area of the sampling area may be relatively large. Thus, typically the sampling area may be a high surface structure, defining a small volume for collecting the sample, e.g. upon diffusion thereof across a membrane, and in turn allowing the gas to diffuse to the sampling chamber. The volume defined by the sampling area should be minimized in order to reduce the response time of the sensor system. In one preferred embodiment of the invention, the sampling area is defined by a membrane arranged adjacent to the sampling cell wall so that the only space for diffusion of the chemical substance between the membrane and the sampling cell wall is the space left by the membrane surface roughness or structure and the sampling cell wall roughness or structure. Likewise, the surface of the sampling area may have a controlled surface roughness or a controlled surface structure defining such very small volume available for diffusion of the sample of the chemical substance.

The arrangement of the light beam optical path relative to the sampling area may be accomplished in at least two different ways.

Thus, the light beam optical path may be situated adjacent to the sampling area so that light beam optical path is in direct contact with the sampling area. In this way the gaseous sample diffuses direct from the sampling area to the light beam optical path.

Alternatively, the light beam optical path may be embedded in the optical sampling cell. In such case the sampling cell may further comprise at least one duct between the sampling area and the light beam optical path for diffusion of the gaseous chemical substance from the sampling area to the light beam optical path.

The light emitter and the light receiver of the sensor system according to the invention are preferably integrated with the optical sampling cell. Thus the light emitter may be integrated with the optical sampling cell. Likewise, the light receiver may be integrated with the sampling cell. Preferably, both of the light emitter and the light receiver are integrated with the sampling cell.

The term “integrated with the optical sampling cell” shall mean that the light emitter and/or the receiver may be held by the sampling cell, e.g. glued or otherwise attached thereto or assembled therewith, or it may be fully integrated therewith, i.e. manufactured as one single structure, e.g. on one single wafer board.

It should be understood, that according to the invention, the sampling cell may integrate up to the entire sensor system including any opto-electronic detection circuit, controller, the light source, any beam splitter including any transmitters. In such case, the sampling cell may be a semiconductor, like silicon or group III-V compounds, taking advantages of the micro-electronic fabrication processes.

Preferably the sensor system according to the invention is temperature controlled. Thus the sensor system may comprise a heating system, such as a heating coil, a Peltier element and/or a heating electronic device. Likewise, the sensor system may comprise a temperature sensing system, such as thermistors and/or electronic chip sensors.

In a number of preferred embodiments of the invention the sensor system may be adapted to multiple detection operation. “Multiple detection” covers the detection of additional chemical species or isotopes, the simultaneous detection of the same chemical species in a plurality of samples as well as the simultaneously detection of different chemical substances from different samples.

Thus, the sensor system may further comprise at least one additional optical sampling cell, which in turn may be arranged in series or in parallel with the optical sampling cell. Preferably the optical sampling cell and the at least one additional sampling cell are integrated in a single sampling cell body.

For the detection of additional chemical substances or for the detection of the chemical substance in additional samples, the sensor system may comprise at least one additional light emitter. Likewise, the sensor system may comprise at least one additional light receiver. Preferably the sensor system may comprise an additional light emitter and an additional light receiver, which are adapted work in combination. Alternatively, the additional light receiver may work along with the light receiver, detecting e.g. different harmonics of the light signal or combined with a different wavelength-modulation or frequency-modulation.

In a further alternative embodiment of the invention the light emitter is a tunable wavelength light emitter for detection of multiple chemical substances or multiple isotopes.

According to another aspect of the invention a sampling cell assembly for use with a sensor system according to the first aspect of the invention is provided, said sampling cell comprising an optical sampling cell holding a sampling chamber for receiving a sample comprising the chemical substance, and a membrane adjacent to the sampling chamber.

As described above the sampling cell assembly may be disposable to minimize inter-sample contamination.

In the following different embodiments of the invention are described with reference to the accompanying drawings in which:

### BRIEF DESCRIPTION OF THE DRAWINGS

The accompanying drawings, which are incorporated in and constitute a part of this specification, illustrate embodiments of the invention and together with the description serve to explain the principles of the invention. In the drawings:

FIG. 1 shows a schematic of the sensor system according to an exemplary embodiment of the invention.

FIG. 2 shows a schematic of the sensor system with a fiber-based light emitter and receiver and a membrane.

FIG. 3 shows a schematic of the sensor system with a lensed-fiber light emitter and light receiver and a reference light beam.

FIGS. 4a and 4b show a schematic of the light beam optical path including a deviated and/or split light beam path.

FIG. 5 shows a schematic of the sensor system with a guiding structure.

FIG. 6 shows a schematic of the sensor system with an embedded guiding structure and ducts.

FIG. 7 shows a schematic of the sensor system with a spiral-shaped guiding structure.

FIG. 8 shows a schematic of the sensor system with a folded light beam optical path including micro-mirrors.

FIG. 9 shows a schematic of a sensor system with a medium pipe.

FIG. 10 shows a schematic of the sensor system with a sampling area structure.

FIG. 11 shows a schematic of the sensor system with additional sampling cells connected in series and parallel.

FIG. 12 shows a schematic of the sensor system with multiple light emitters.

### DESCRIPTION OF PREFERRED EMBODIMENTS

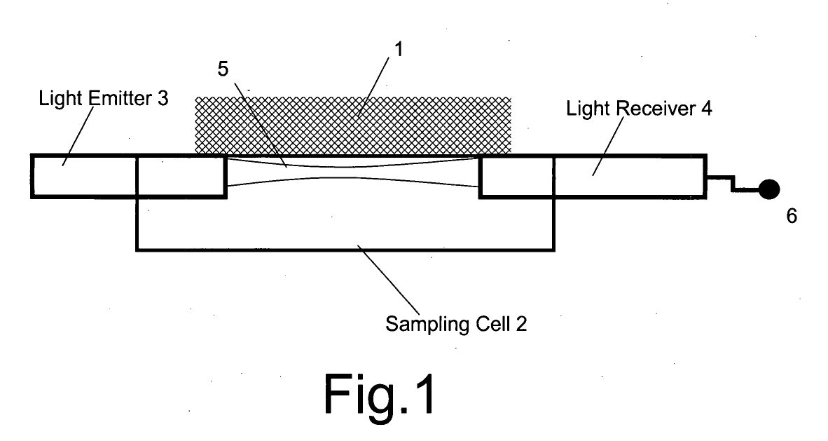

The sensor system according to an exemplary embodiment of the invention is shown in FIG. 1. The sensor system is adapted for detection of a chemical substance in a medium (1), and comprises a sampling cell (2), a light emitter (3) and a light receiver (4) arranged to produce and detect a light beam (5).

The light emitter may be any device based on a light source, like lasers, laser diodes and light emitting diodes, which light is coupled into the sampling cell, producing the light beam. Likewise, the light receiver may be any device like an opto-electronic circuit for detecting light from the sampling cell to produce an output signal (6) reflecting the sensed chemical substance concentration in the medium.

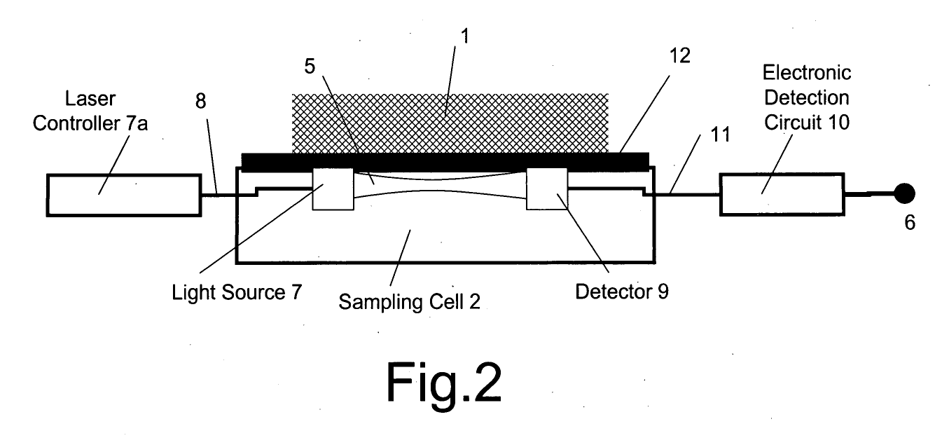

The sensor system shown in FIG. 2 shows that the light source (7) of the light emitter may be held by the sampling cell (2) and controlled through a transmitter (8), e.g. by a laser controller (7a) in terms of current, power and/or wavelength, so that the intensity of the emitted light beam (5) is processed.

The sensor system shown in FIG. 2 also shows that the detection circuit of the light receiver being connected to the sampling cell. The measurement signal of the detector (9) is delivered to the electronic detection circuit (10) through the transmitter (11) like an optical lensed fiber, a simple electric wire or a wireless transmitter.

The sensor system shown in FIG. 2 also includes a membrane (12) separating the medium (1) and the sampling cell (2). The membrane prevents part of the medium to interact within light beam.

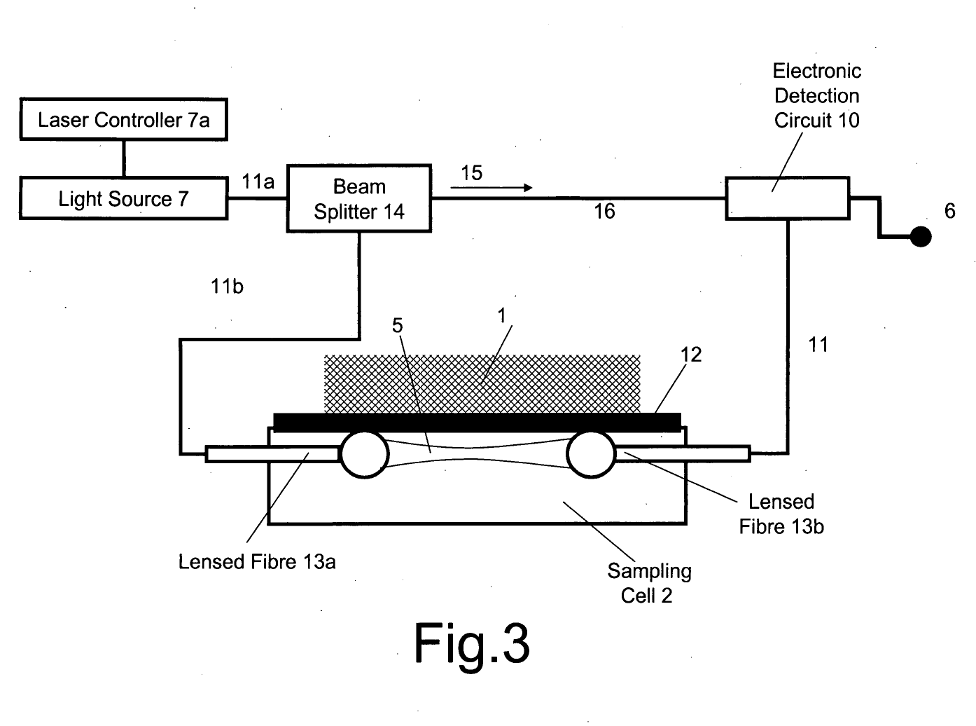

With the sensor system variant shown in FIG. 3 both of the light emitter and the light receiver are based on lensed-fibers (13a, 13b), for coupling light from the light source into the sampling cell, for producing the light beam, and for detecting the light beam transmitted to the electronic detection circuit. It should be understood that the light source and the electronic detection circuit may be located close to or even integrated within the sampling cell or in a remote position from the sensing location. Remote sensing is typically the case for transcutaneous blood gas monitoring when the sensing takes place on the patient skin and the light source and/or output signal monitor is/are located on the patient bedside. The lensed-fiber may in turn be replaced by any fiber-like waveguide, with or without polarization maintaining properties, which fiber-like waveguide tip is modified as or assembled to a lens or any device fulfilling similar purpose in order to change the output beam wavefront, e.g. divergence, collimation or focusing.

The sensor system shown in FIG. 3 also shows a beam splitter (14), such as a fiber optical coupler or free-space beam splitting prism, to produce a reference signal (15) for differential detection and/or balanced detection. The reference signal may be given by the light emitter, or sampled from the light beam before or along sensed chemical substance interaction, and transmitted to the light receiver by a transmitter (16) like an optical fiber, a waveguide, an electric wire or even a wireless system.

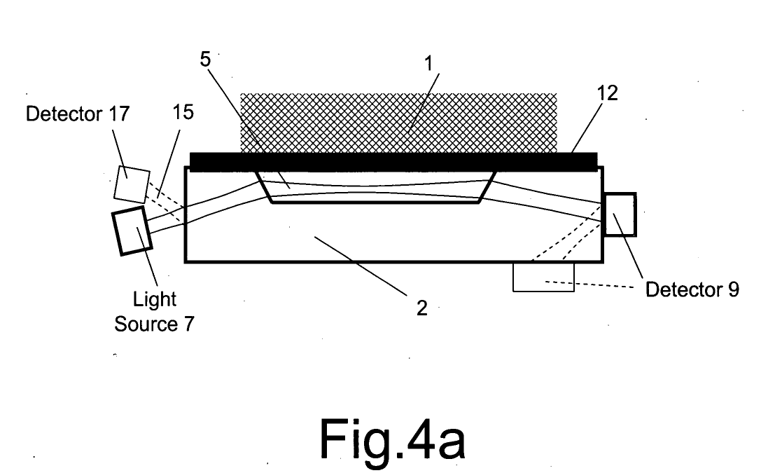

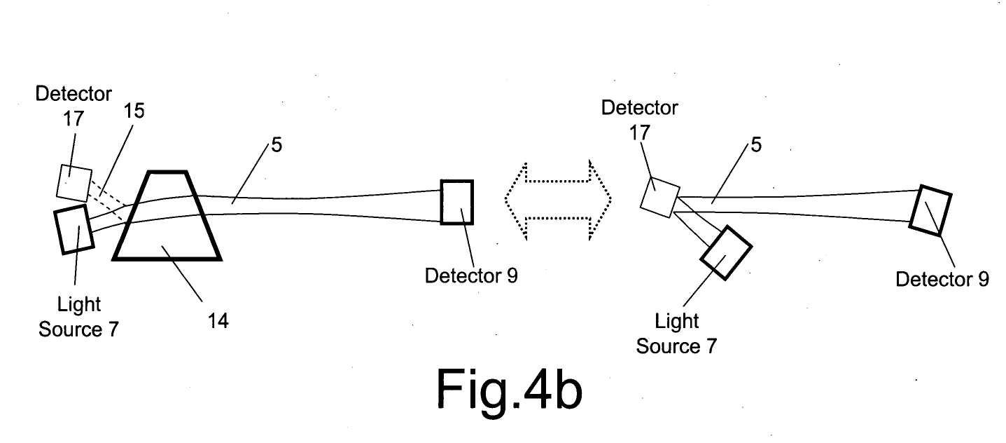

The sensor system shown in FIG. 4a uses the advantage of deviating the light beam by refraction, reflection, diffraction or any combination thereof, thereby extending the light beam optical path. In this case a beam splitter generates a reference signal (15) which may be detected by an additional detector (17). With this figure, and with FIG. 4b, solid lines represent refraction, whereas dashed lines represent refraction and reflection.

FIG. 4b shows how a prism (14), deviating and splitting the light beam, may be reduced to the detector (17) used as partial reflector and providing simultaneously a reference signal and the deviation of the light beam. This may be considered as the integration of the detector in the beam splitter and vice-versa.

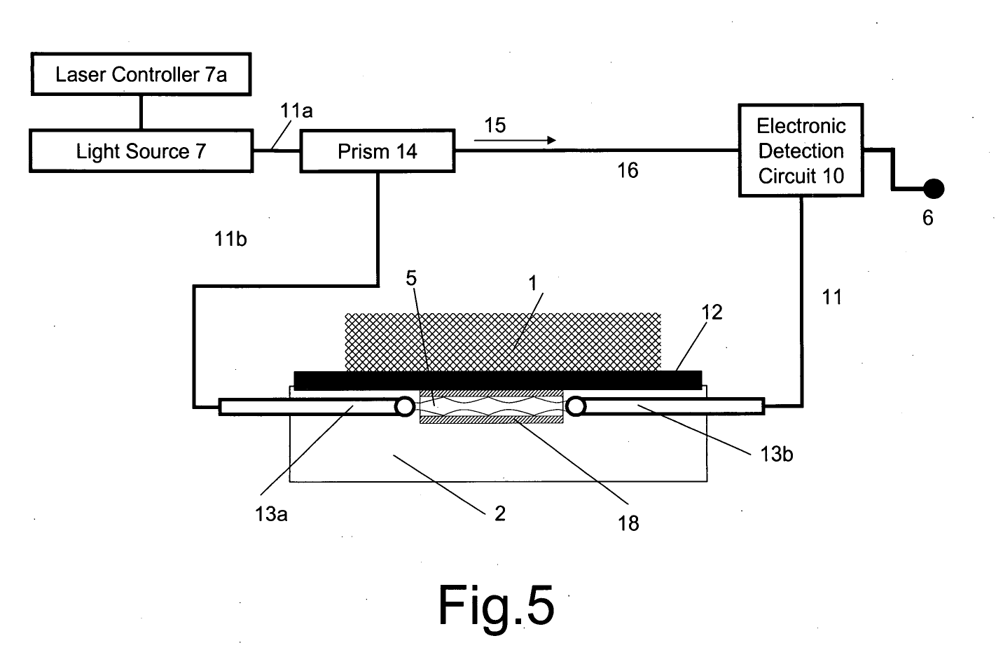

FIG. 5 shows the sensor system including a guiding structure (18) which may be a hollow cavity acting to guide the light beam. With the guiding structure the extension of the light beam is limited, and the interaction length between the light beam and the chemical substance may be extended.

The internal surface of the guiding structure may have particular absorption, reflection or scattering properties given by the microstructure itself or any additional surface treatment, such as a reflecting coating.

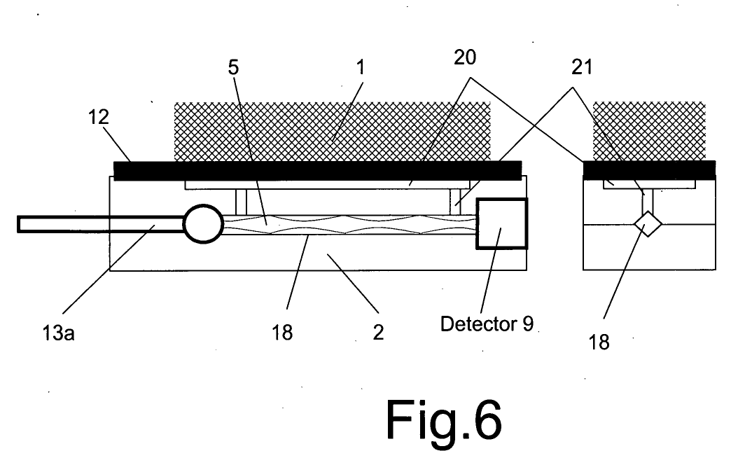

FIG. 6 shows the sensor system in which the guiding structure is embedded in the sampling cell and connected to the sampling area (20) by one or several duct(s) (21). The purpose of the duct(s) is to let the chemical substance diffuse or flow, from the collecting area, along the duct(s), to the sampling chamber for sensing interaction.

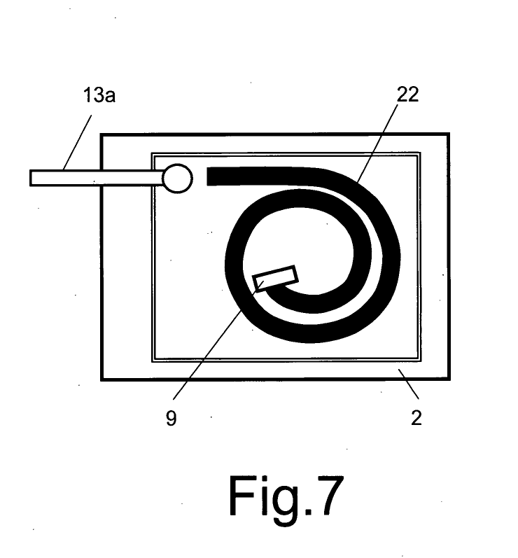

FIG. 7 shows a spiral-shaped guiding structure (22). The light beam path may have a wide range of shapes, in order to increase of the interaction length between the light beam and the chemical substance while keeping the sensor system compact. Typical shapes include straight shapes, U-shapes or spiral-shapes, which are preferably located about the top surface, i.e. close to the medium and the sampling area.

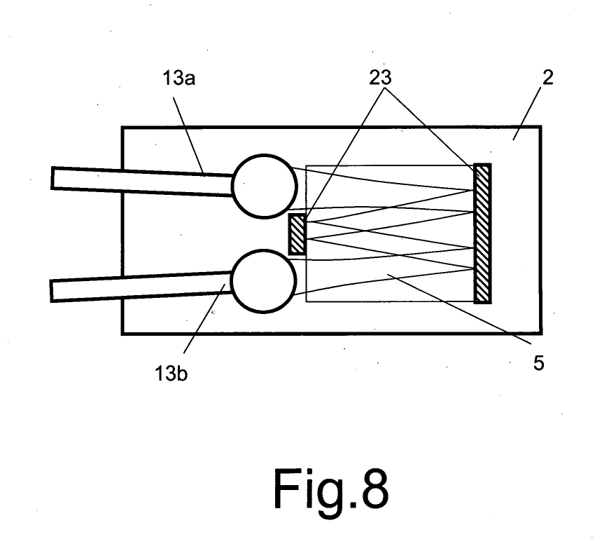

The FIG. 8 shows the sensor system with a folded optical light beam path, the light beam path being folded by means of one or more micro-mirrors (23) reflecting the light beam.

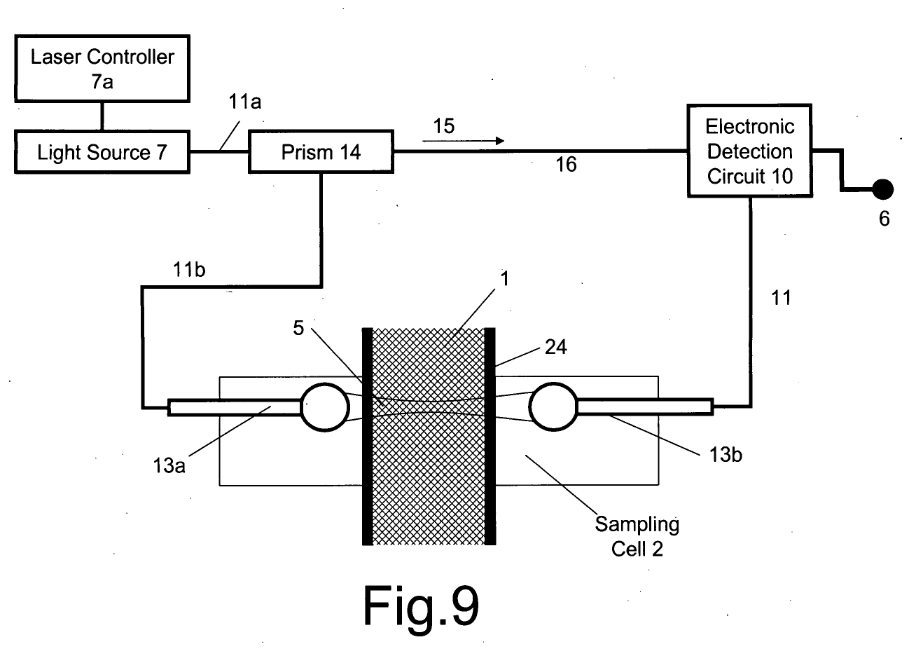

The sensor system as shown in FIG. 9 displays a medium pipe (24) which is an intermediate cavity acting as a pipe for the sensed medium and crossing the light beam. The purpose of the medium pipe is to allow the medium (1) to flow or diffuse across and not on top of the sampling cell. The medium pipe may be applied along a (micro-)fluidic system simply by connecting or integrating the medium pipe to (micro-) fluidic system pipeline.

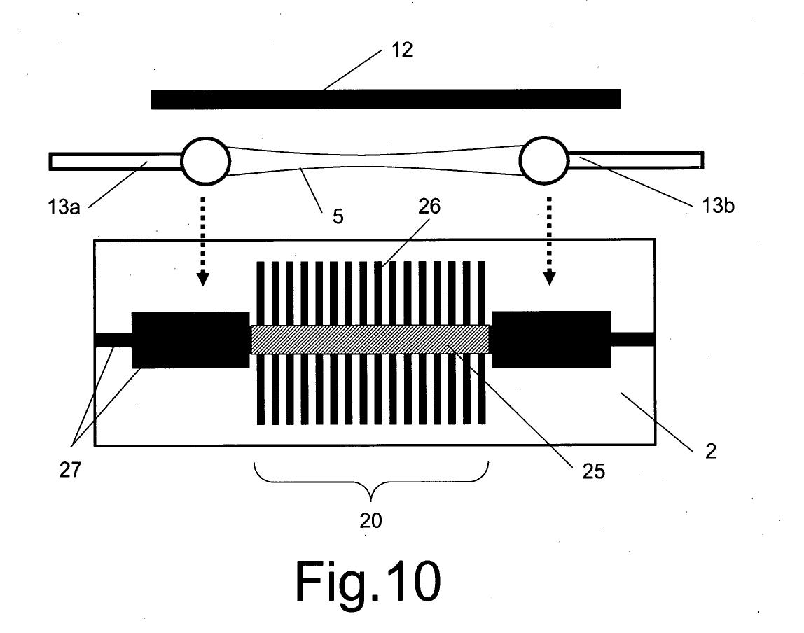

An important parameter for the sensor system of the invention is the response time. The response time in turn is related to sampling structure, i.e. to optimize the ratio of the sampling area to the sampling chamber. FIG. 10 shows the sensor system with a sampling area (20) with a sampling microstructure (26). The sampling area should be as high as possible to gather the sensed chemical substance, from a large surface towards the sampling chamber (25). The sampling area is connected directly or indirectly to the sampling chamber allowing the chemical substance to diffuse or flow towards the light beam for sensing interaction. Thus, the sampling area may be integrated within the sampling cell, it may be built as a discrete element or it may be integrated with the membrane. The microstructure may be of various cross-sections but preferably have a shallow depth so that its contribution to the total sampling volume is minimized. The conformation of the sampling area, meaning the arrangement of the microstructure may vary from the absence of micro-channels to striped, crossed or fractal conformations. Also the manufacturing process, meaning the surface roughness, may be considered as a microstructure for the sampling area. Even a porous layer may be seen as sampling area microstructure. The sampling area may be expanded to the entire sampling cell top surface and even wider over other facets and/or over adapted elements assembled within the sampling cell.

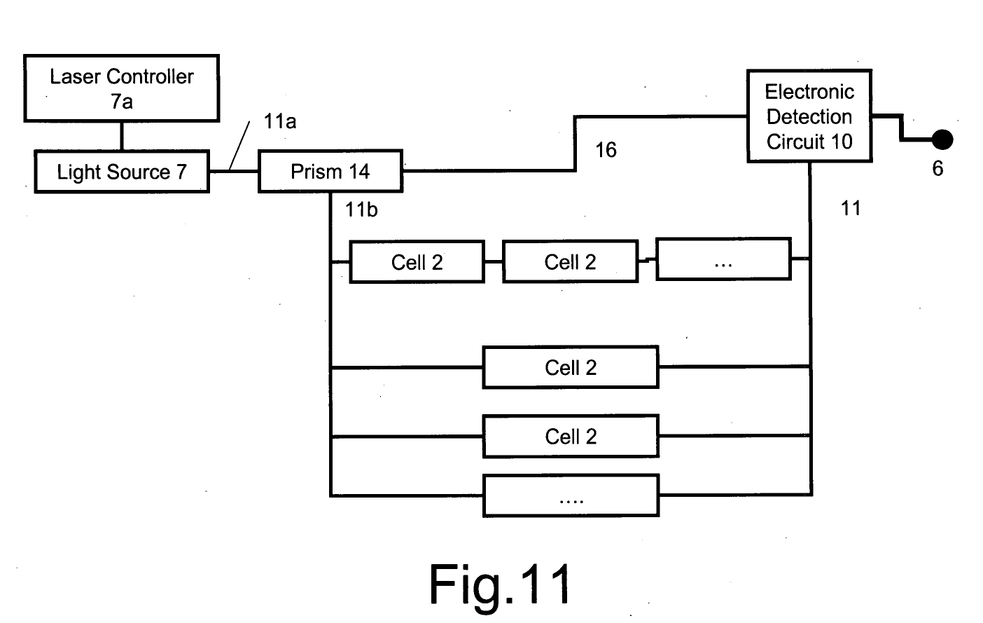

In order to sense chemicals in different locations forming a multi-point optical sensor system as schematically described in FIG. 11, several sampling cells may be combined in series and/or in parallel.

Expanding the scale of integration, the series and/or parallel architectures may be integrated or assembled within a single (or a reduced number of) sampling cell body (bodies) to form a compact sensor system.

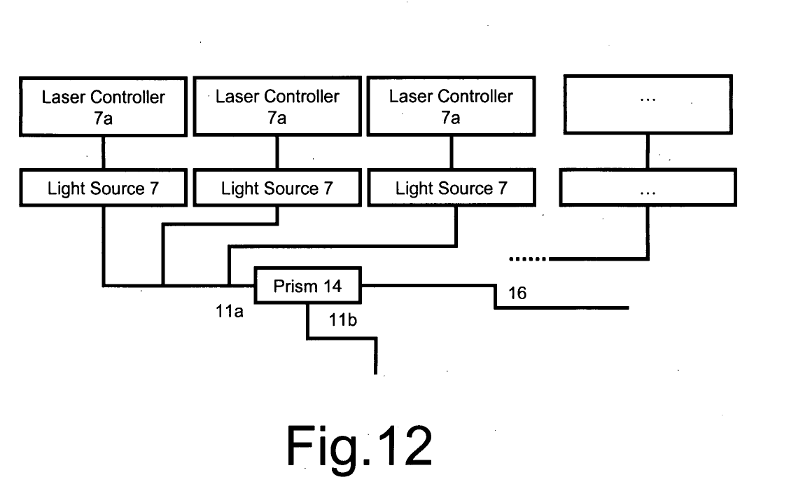

In order to sense different chemicals or isotopes, one or multiple light sources, tunable or with fixed wavelength, may be applied forming a multiple light source sensor system as schematically shown in FIG. 12.

According to the targeted application, all the above described embodiments may be combined for optimal sensing.

The following describes specific embodiments of the invention in which the sensor system has a sensor-head encompassing the sampling cell and remotely connected via a cable from an instrument. The instrument encompasses the laser light source, the laser controller, the beam-splitter of the light emitter, and the reference detection opto-electronics, the signal treatment electronics of the light receiver and also the power supply and the output signal display. It is applied in transcutaneous blood gas monitoring where the patient skin is heated for better correlation between arterial partial pressure and transcutaneous partial pressure (Severinghaus correction is applied). The gas monitored in this embodiment is carbon dioxide.

The laser source (20 mW) emits wavelength modulated light of 1572 nm, 2004 nm or 4260 nm according to CO₂ absorption peaks. The laser is wavelength-modulated at 500 Hz by its driving current. The light beam is injected into a monomodal standard telecom optical fiber (SMF-28). The beam splitter provides a reference signal (10%) and a measurement signal (90%), which latter is guided along the 2 m-long cable into the sensor-head. The sensor-head is based on optical sampling cell (<5 mm³ sampling volume) allowing both the collection of the gases permeating from the patient skin (ø 20 mm sensing area) and the interaction between light and the sensed gas (physical principle of light absorption over a central channel of ø 0.4 mm×15 mm). At the end of the optical fiber a micro-lens, i.e. a lensed-fiber, collimates the light beam in the central channel of the sampling cell, where the sensed gas is collected by diffusion through a Teflon membrane and ducts of a diameter of 0.2 mm). The micro-lens shapes the beam for high signal-to-noise system performance. It is anti-reflection coated and it keeps a single monomodal free-space propagation along the central channel of the sampling cell. This avoids back reflection and parasitic noise (interferometric noise) all along the light-gas interaction path. At the end of the central channel an InGaAs photodetector measures the light intensity, which normalized modulation reflects the sensed gas concentration (0-760 mm Hg range given by fitting, linearization function and calibration factor set at factory). The photodetector arrangement avoids back reflection and allows for low interferometric noise sensing. High sensitivity is obtained by wavelength modulation of the light and demodulation after the photodetector, comparison to the reference signal and harmonic detection provides a rejection of the common fluctuations and improves the system performance. High selectivity is given by the very narrow spectral width of the laser source targeting a single absorption line of the sensed gas (about 10 GHz wide). The signal processing converts the light intensity signal into gas partial pressure (pCO₂ or tc-pCO₂ for transcutaneous) displayed at a 1 sec rate.

In an alternative embodiment, a hollow core fiber (core diameter=11 μm, numerical aperture=0.1) designed to be monomodal with a 1572 nm wavelength (D=11 μm<(2.405*1.572 μm/3.14*0.1)=12 μm) is inserted as a guiding structure in the central channel of the above embodiment and directly connected to the standard telecom fiber. The hollow core fiber has been chosen for fitting the telecom fiber beam and optimizing single monomodal propagation (low parasitic noise and optimal signal-to-noise ratio). More than 90% of the light propagates in the air core of the hollow fiber. The central channel holding the hollow core fiber can be freely curved (90°, coiled, U-shape) as the hollow fiber is flexible while keeping the propagation monomodal.

Transcutaneous partial pressure measurement ranges from 0-250 mm Hg. A good correlation with the patient blood gas level (PaCO₂) is obtained by heating the patient skin temperature at 41-43° C. (heating coil around the sampling area and metallic sampling cell for heat conduction) generating an arterialization of the under-skin vessels. Thus, by continuous monitoring, a patient cardiopulmonary disorder can be detected with a response time shorter than 60 sec allowing alerted medical staff to react before central nervous system damage due to lack or excess of ventilation.

It will be apparent to those skilled in the art that various modifications and variations can be made in the sensor system and the sampling cell of the present invention without departing from the spirit or scope of the invention. Thus, it is intended that the present invention cover the modifications and variations of this invention provided they come within the scope of the appended claims and their equivalents.

1. A sensor system for detection of a gaseous chemical substance in a medium, said sensor system comprising:
an optical sampling cell holding a sampling chamber having a volume of at most 20 mm³ for receiving a sample comprising the gaseous chemical substance,
a light emitter for generating and coupling a light beam into the sampling cell for free-space propagation along a light beam optical path within the sampling cell for interaction with the gaseous sample held in the sampling chamber, and
a light receiver to detect the light beam from the sampling cell and to produce an output signal reflecting the gaseous chemical substance of the sample,
wherein the light beam propagates by single monomodal propagation.

2. The sensor system according to claim 1 in which the volume of the sampling chamber is at most 5 mm³.

3. The sensor system according to claim 1 in which the volume of the sampling chamber is at most 0.5 mm³.

4. The sensor system according to claim 1 in which the sampling chamber fits the light beam cross-section along the light beam path.

5. The sensor system according to claim 1 in which the sampling chamber is adapted to the light beam cross-section along the light beam path.

6. The sensor system according to claim 1 further comprising a guiding structure in which the light beam propagates.

7. The sensor system according to claim 6 in which the sampling cell comprises the guiding structure.

8. The sensor system according to claim 6 in which the guiding structure is a rectangular mirror guiding structure which has a characteristic dimension Dₘᵢᵣᵣₒᵣ and the light beam has a wavelength λ, wherein Dₘᵢᵣᵣₒᵣ/λ<(π)^{-0.5}.

9. The sensor system according to claim 6 in which the guiding structure is a rectangular dielectric guiding structure having a dielectric core and a dielectric cladding, a characteristic dimension D_{dielectric} and a numerical aperture NA defined as (n₁²-n₂²)^{0.5}, where n₁ and n₂ represent the dielectric core and the dielectric cladding refractive indices, respectively, and in which the light beam has a wavelength λ, wherein D_{dielectric}/λ<1/(π^{0.5}*NA).

10. The sensor system according to claim 6 in which the guiding structure is a circular dielectric guiding structure of a diameter D_{circular} and a numerical aperture NA_{circular}, and in which the light beam has a wavelength λ, wherein D_{circular}/λ<2.405/(π*NA_{circular}).

11. The sensor system according to claim 6 in which the guiding structure receives the sample.

12. The sensor system according to claim 6 in which the guiding structure is a hollow optical device selected from the group of tubes, hollow fibers, multi-hole fibers, photonic crystal fibers and photonic band gap devices.

13. The sensor system according to claim 6 in which the guiding structure is straight.

14. The sensor system according to claim 6 in which the guiding structure is bent, coiled, folded, U-shaped or spiral-shaped.

15. The sensor system according to claim 1 in which the light emitter is narrow band light emitter.

16. The sensor system according to claim 15 in which the narrow band light emitter is selected from the group of distributed feedback laser diodes, vertical-cavity surface-emitting lasers and quantum cascade lasers.

17. The sensor system according to claim 15 in which the gaseous chemical substance has an absorption line and in which has a band width at −3 dB of at most the FWHM (full width at half maximum) of the gaseous chemical substance absorption line

18. The sensor system according to claim 1 in which the light emitter comprises a collimator.

19. The sensor system according to claim 1 in which the light emitter comprises a beam shaper.

20. The sensor system according to claim 1 in which at least one of the light emitter and the light receiver comprise a fiber.

21. The sensor system according to claim 1 in which at least one of the light emitter and the light receiver comprises a lensed-fiber.

22. The sensor system according to claim 1 further comprising at least one beam splitter splitting the light beam into a sampling cell light beam and a reference light beam.

23. The sensor system according to claim 1 in which the light emitter is wavelength-modulated and the light receiver is adapted for fundamental detection.

24. The sensor system according to claim 1 in which the light emitter is wavelength-modulated and the light receiver is adapted for harmonic detection.

25. The sensor system according to claim 1 in which the light emitter is frequency-modulated and the light receiver signal treatment is adapted for fundamental detection.

26. The sensor system according to claim 1 in which the light emitter is frequency-modulated and the light receiver is adapted for harmonic detection.

27. The sensor system according to claim 1 in which a thermo-mechanical device intentionally perturbs interferometric noise for its statistical reduction.

28. The sensor system according to claim 1 in which a thermo-mechanical device intentionally scrambles interferometric noise for its statistical reduction.

29. The sensor system according to claim 1 in which the light receiver applies a signal treatment normalization process

30. The sensor system according to claim 1 in which the shape of the light beam optical path is modified by refraction, reflection, diffraction or scattering.

31. The sensor system according to claim 1 in which the length of light beam optical path is extended by refraction, reflection, diffraction or scattering.

32. The sensor system according to claim 1 in which the sampling cell comprises a membrane adjacent to the sample chamber.

33. The sensor system according to claim 32 in which the membrane and at least part of the sampling cell are integrated into a sampling cell assembly, and in which the sampling cell assembly is disposable.

34. The sensor system according to claim 1 further comprising a medium pipe crossing the light beam optical path.

35. The sensor system according to claim 1 in which the sampling cell has a sampling area for sampling the chemical substance.

36. The sensor system according to claim 35 in which part of the light beam optical path is situated adjacent to the sampling area.

37. The sensor system according to claim 35 in which part of the light beam optical path is embedded in the optical sampling cell and the sampling cell further comprises at least one duct between the sampling area and the light beam optical path.

38. The sensor system according to claim 1 in which at least one the light emitter and the light receiver are integrated with the optical sampling cell.

39. The sensor system according to claim 38 in which the light emitter is integrated with the optical sampling cell.

40. The sensor system according to claim 1 further comprising at least one additional optical sampling cell arranged in series with the optical sampling cell.

41. The sensor system according to claim 1 further comprising at least one additional optical sampling cell arranged in parallel with the optical sampling cell.

42. The sensor system according to claim 1 further comprising at least one additional optical sampling cell, wherein the optical sampling cell and the at least one additional optical sampling cell are integrated into a single optical sampling cell body.

43. The sensor system according to claim 1 further comprising at least one additional light emitter and at least one additional light receiver.

44. The sensor system according to claim 1 further comprising at least one additional light emitter.

45. The sensor system according to claim 1 further comprising at least one additional light receiver.

46. The sensor system according to claim 1 in which the light emitter is a tunable wavelength light emitter for detection of multiple chemical substances.

47. The sensor system according to claim 1 in which the light emitter is a tunable wavelength light emitter for detection of multiple isotopes.

48. The sensor system according to claim 1 in which the sensor system is a transcutaneous sensor system.

49. The sensor system according to claim 1 in which the gaseous chemical substance is carbon dioxide.

50. A sampling cell assembly for use with a sensor system for detection of a gaseous chemical substance in a medium, said sensor system comprising a light emitter for generating and coupling a light beam into the sampling cell assembly for free-space propagation along a light beam optical path within the sampling cell assembly for interaction with a gaseous sample held in the sampling cell assembly, and a light receiver to detect the light beam from the sampling cell assembly and to produce an output signal reflecting the gaseous chemical substance, the sampling cell assembly comprising:
an optical sampling cell holding a sampling chamber having a volume of at most 20 mm³ for receiving a sample comprising the gaseous chemical substance, and
a membrane adjacent to the sampling chamber,
wherein the lightbeam propagates by single monomodal propagation.
